(19) United States
(12) Patent Application Publication
(10) Pub. No.: US 2009/0271398 A1
(43) Pub. Date: Oct. 29, 2009

(54) METHOD AND SYSTEM FOR RECOGNITION OF VIDEO CONTENT

(76) Inventors: Steven D. Scherf, Fremont, CA (US); Gregory Allan Funk, Berkeley, CA (US)

Correspondence Address: SCHWEGMAN, LUNDBERG & WOESSNER, P.A., P.O. BOX 2938, MINNEAPOLIS, MN, 55402, US

(21) Appl. No.: 12/429,400

(22) Filed: Apr. 24, 2009

Related U.S. Application Data
(60) Provisional application No. 61/047,894, filed on Apr. 25, 2008.

(51) Int. Cl. G06F 17/30

(52) U.S. Cl. 707/5; 707/E17.017

(57) ABSTRACT

A method and system is provided for recognizing video content represented by temporally segmented video content. An example system includes a communication module and a search and match module. The communications module may be configured to receive a source table of contents (TOC) related to a temporally segmented video content. The source TOC may include one or more titles and a source playback length. The search and match module may be configured to interrogate a video products database with the source TOC to determine one or more match results, utilizing a fuzzy matching technique.

### RELATED APPLICATIONS

This patent application claims the benefit of priority, under 35 U.S.C. Section 119(e), to U.S. Provisional Patent Application Ser. No. 61/047,894, filed on Apr. 25, 2008, which is incorporated herein by reference in its entirety.

### TECHNICAL FIELD

This application relates to matching techniques and to a method and system for recognition of video content.

### BACKGROUND

Video content, e.g., stored on a video disc, such as digital versatile disc (DVD), may be divided into titles and chapters. A title is a playable feature, while a chapter is an individual segment or scene in the title. A table of contents (TOC) may consist of the timing and/or offset information indicating playback locations and/or times of each title and chapter, as determined by examining playback information on the media.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system for recognition of video content may be implemented;

FIG. 2 is a diagrammatic representation of an environment within which an example method and system for recognition of video content is provided at a client system, in accordance with one example embodiment;

FIG. 3 is block diagram of a system for recognition of video content, in accordance with one example embodiment;

FIG. 4 is a flow chart of a method for recognition of video content, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system for recognition of video content, otherwise referred to as a video recognition system, is described. In the following description, for purposes of explanation, numerous specific details are set forth in order to provide a thorough understanding of an embodiment of the present invention. It will be evident, however, to one skilled in the art that the present invention may be practiced without these specific details.

As mentioned above, a table of contents (TOC) of video content may include the timing and/or offset information indicating playback locations and/or playing times of each title and chapter. These values tend to be fairly unique, allowing for their use as an identifier. Because the timing and offset values are not guaranteed to be unique, and because devices may not always report numbers for all available titles and chapters, using these numbers for matching a source TOC with a reference TOC from a database presents various technical problems. An example video recognition system is provided to match similar or related video discs, as well as to determine how the matched discs are related. The system may be configured to permit matching of video discs in different encodings, or even to match discs in different formats. For example, the same movie may appear on both a DVD and a Blu-ray disc, and therefore it may be beneficial if a video recognition system is configured to determine whether the source video disc information of a DVD is associated with the same content (e.g., the same movie) as video disc information of a Blu-ray disc. An example video recognition system may be extended to any type of video content that has the concept of segmentation of media objects (e.g., chapters in a movie). It will be noted that, while references are made throughout the specification to a video disc, the video recognition system described herein may be used advantageously to recognize any media (e.g., a set of video files) that has a certain segment structure that is temporally versatile enough to be sufficiently unique for a particular content item. Some other examples of video disc formats that may be accepted by the video recognition system include, e.g., High-Definition/Density (HD) DVD's and Video Compact Disc (VCD), Super Video Compact Disc (sVCD), Laserdisc and derivatives of these formats.

An example video recognition system may be configured to match a TOC of a source disc with a record in a media database even when only partial TOC for the source disc is available. For example, a device, such as a DVD drive in a computer system, may not able to report all available TOC information for a disc. An example video recognition system may be configured to match the disc with one or more records in a media database even when not all main titles are available from the device (e.g., where a disc has multiple main titles associated with multiple episodes of a television series) or when only a subset of chapters associated with the main title of the disc is available from the device

An example video recognition method may be implemented to include two phases: a search phase and a match phase. During the search phase, potential candidates (potentially matching records) are identified in a database, so that fewer matches need to be performed during the matching phase. The search phase is directed at searching for potential matches that would include discs with identical TOCs, as well as discs with slightly different TOCs, or even discs with very different TOCs that share one or more identical or similar titles. The match phase is directed at determining whether two TOCs (a source TOC associated with a source video disc that is the subject of the recognition and a reference TOC from a video products database) are a match of some type. The matching process targeted at determining an exact match between two TOCs may include, e.g., a bit-for-bit comparison, or comparing respective message digests of the two TOCs. A fuzzy matching approach may be used where respective TOCs of two discs are similar but not exact, such as where two discs are released in different markets. Another example where TOCs of two discs may differ even where it may be practical to consider the two discs as matching, is where a re-release of a disc has the same main feature (e.g., the featured movie) but different trailers or special features (or even just different menus). Thus, an example video recognition system may be configured to identify similar discs, even if the user's exact disc does not exist in the database.

In operation, during a matching phase, a video recognition system takes two complete or partial disc TOCs (e.g., a source TOC associated with a client device or application and a candidate TOC record from a media database), compares them, and returns a match result. A match result may be characterized as exact match, re-release match, title match, aggressive match, or no match. An exact match may be defined as a match where two disc TOCs are either identical or effectively identical (e.g., allowing a certain amount of variation between the two TOCs to accommodate differences between different pressings of the same disc). A match is considered a re-release match when two discs have the same main and secondary features (e.g., movie titles and trailers/special features), but differ slightly in playback length. The difference is enough that the two cannot be the same release of a the disc, but since they have the same titles they are considered be a release of the movie in a different encoding (e.g., NTSC (National Television System Committee) vs. PAL (Phase Alternating Line)), or a re-mastered version of the same disc. Video content may be encoded in different bit rates (e.g., Superbit releases), where the same movie is encoded differently, and, though the chapters correspond to the same temporal offsets, the chapter pointers into the bit streams are pointing to different locations in the encoded file. Another factor may be the inclusion of different languages in the bit stream which may lead to physically different video files. The characterizing feature that may be used in the matching process is the temporal correspondence during play back. Another example of different versions of the same video disc is associated with copy protection. Sometimes, the first portion of a file is unreadable by a video player device. During playback, this is not a problem as the first chapter starts with an offset into the file, so this portion of the file that cannot be played back is never accessed. In the process of video recognition, however, looking at the file size alone in this case would be misleading as well, as would looking at the absolute offsets of the chapter pointers into that file. An example video recognition system may be configured to use fuzzy matching to accommodate the above-mentioned differences that may be present in different versions of the same video content.

Such discs can be considered the same product for all practical purposes, even though they represent respective different versions of that product. A match is considered a title match when two discs are different products but contain one or more main features in common. Examples of this are when a movie appears on both the “regular” and “special edition” discs, or when a television (TV) episode appears on two different compilations of a TV series collection.

Example techniques for recognition of video content may be utilized advantageously by device manufacturers and software application developers, as these techniques provide a comprehensive solution to permit consumers to more easily navigate disc collections, and learn more about films, television shows, and other media. When a user places a DVD or Blu-ray disc in their device or application, it may be readily recognized by the system described herein. Title, edition, release year, cover art, running time, rating, cast/credits, genre, synopsis, and many other metadata fields may be delivered for each video disc. In one example embodiment, a system for recognition of video content may be configured to identify reference disc information files that are found in a DVD drive, a disc changer device, on a local hard drive, or on a network storage device. reference disc information files are typically associated with commercial video discs. For the purposes of this description, a video disc is considered to be a commercial disc if it has been released for purchase, as opposed of a home-made (personal burn) video disc, for example.

In one example embodiment, a video recognition system may operate as follows. The system receives a source TOC of a disc that is the subject of the recognition. The source TOC may be provided by a module running locally to the recognition system or by a remote client over a network connection. The event of sending the source TOC to the video recognition system or receiving the source TOC at the recognition system may be considered as a request to identify a matching reference disc information file from a database that corresponds to the video disc associated with the source TOC.

When the recognition system receives the TOC and an associated request for matching, the recognition system uses at least partial information from the TOC to determine any matching reference TOCs that are present in the media database using fuzzy (or non-exact) matching techniques and returns the results of the matching to the requesting entity. The requesting entity may be, for example, a recognition-enabled computer program, such as a video player program configured to detect that a video disc is present in a video drive and to cause a TOC of that video disc to be provided to the recognition system. There may be implemented a variety of fuzzy matching methods as is described in more detail further below. Prior to presenting the results of the matching to the requesting entity, the recognition system may apply a verification technique to the match results to determine and eliminate any false positives.

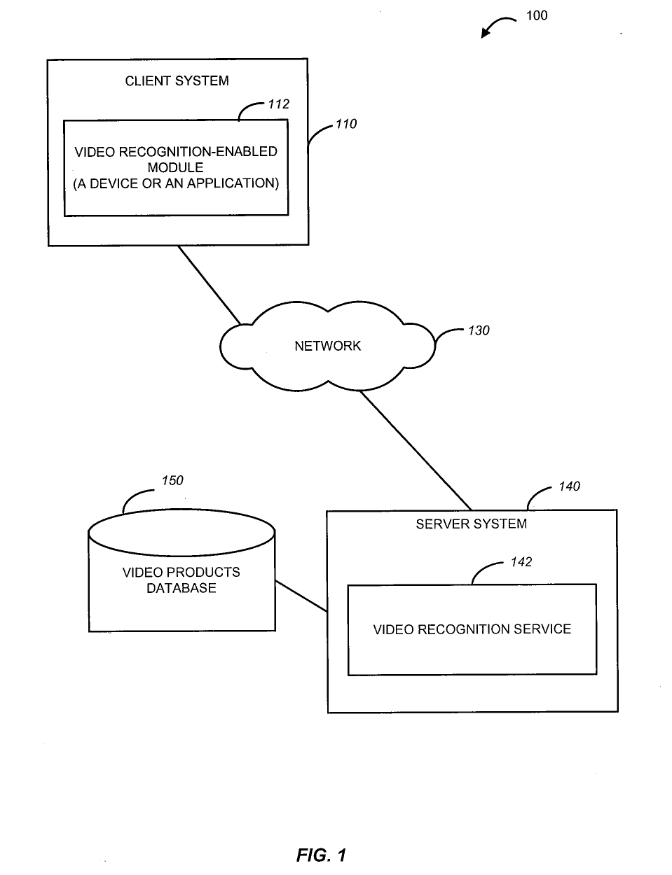

An example video recognition system may be implemented in the context of a network environment 100 illustrated in FIG. 1. As shown in FIG. 1, the network environment 100 may include a client system 110 and a server system 140. The server system 140, in one example embodiment, hosts a video recognition service 142. The client system 110 is shown as hosting a video recognition-enabled module 112, such as a video player application capable of detecting and playing video discs that may be present, e.g., in a video disc drive or stored on a hard drive associated with the client system 110. The client system 110 may have access to the server system 140 and its video recognition service 142 via a communications network 130. The communications network 130 may be a public network (e.g., the Internet, a wireless network, etc.) or a private network (e.g., a local area network (LAN), a wide area network (WAN), Intranet, etc.).

Also shown in FIG. 1 is a video products database 150 (also referred to as a media database). The video products database 150 may store reference TOCs of video disc products and can be utilized by the video recognition service 142 to determine a video product that matches a TOC received from the client system 110. The video products database 150 may be accessible to the video recognition service 142 via a network, or it may reside locally with respect to the server system 140.

As mentioned above, an example module for recognizing video content, such as the video recognition service 142, may be implemented to perform a two-step process: search for candidate TOCs, followed by comparison of the source TOC against the match candidates. An index for the video products database may be created to facilitate fast lookup. In one example embodiment, the recognition module indexes only main titles from the TOCs stored in the video products database. Titles that are merely “interesting” (e.g., titles that have certain length with respect to the longest main title in the TOC) are not indexed. Thus the generated index may be maintained in real-time and updated as TOC records are added to and deleted from the video products database.

Many forms of fast indexing may be used to locate candidate TOCs based on a source TOC. In one example implementation, the index takes the form of an in-memory hash array of arbitrary size, each bucket of which containing a fixed array list of pointers to TOCs in the video products database. The hash array is a two-dimensional array indexed by the number of chapters in the title, as well as (for example, but not restricted to) the middlemost chapter play length. Thus, all titles that are potentially re-master matches (and therefore also potentially exact matches) of the user's TOC are found in a single bucket. Nearby buckets may be searched to find TOCs that are also re-master matches of slightly lower certainty (but within tolerance).

In one example embodiment, when a user requests a TOC match, the following steps may be taken. The titles in the source TOC are broken down into three classes: main titles, interesting titles and uninteresting titles. The latter are ignored for matching purposes. Exact matching is attempted. A single main title in the source TOC is chosen at will and looked up in the index, and a candidate list is built (because only one main title lookup is necessary to find all possible exact matches). Each TOC in the candidate list is then compared to the source TOC in its entirety (excluding uninteresting titles). If there is at least one exact match, the result list is returned to the user and the process ends. Re-master matching is then attempted. A new candidate list is constructed by widening the bucket search to all eligible nearby buckets to all titles in the source TOC. Eligibility is determined using the re-master match threshold (e.g., a permissible play length difference) to compute which buckets might contain a re-master match. If there is at least one re-master match for the entire TOC (excluding uninteresting titles), the result list is returned to the user and the process ends. Title matching is then attempted. The candidate list is compiled in a similar manner as in the previous steps, but all main titles are used rather than just one main title. This is allowed in the case of a title match, because title matching determines whether any one of the main titles from the source TOC are present in a reference TOC. Each main title in the source TOC is compared against a reference TOC in the candidate list. If there is at least one TOC with a title that matches to any of the main titles in the source TOC, the result list is returned to the user and the process ends. Another form of matching, that may be termed “aggressive matching,” may be attempted if other types of matching do not produce any match results. In one embodiment, aggressive matching may be attempted only if the client requests it or is known to desire that this step takes place. The process of aggressive matching may be described as a title match, in which the matching thresholds are loosened, and in which a number of chapters is allowed to be missing from either the reference information file or in the main title in the reference TOC or beyond the minimum or maximum individual length threshold. We allow up to one such chapter for every eight in the reference or user feature (whichever has more), though this, as with all matching parameters, is tunable. This approach, in one embodiment, may allow finding otherwise unmatchable records when weak but sufficient similarity exists between a reference information file and a source TOC. If none of the above-mentioned approaches result in a positive match, a “no match” response is returned to the user.

DVDs support the notion of multiple camera angles for a single scene. For example, a movie may have the same scene shot from multiple perspectives, with both camera angles interspersed in a single video stream on the disc. A user may be permitted to select a particular angle, using the “angle” button on a remote control device. The use of multiple camera angles for a single scene introduces hidden frames in the associated TOC, which are optional to include in the chapter lengths. Some existing video disc playing devices choose to include these hidden frames in the TOC (thereby reporting an angle TOC), while others do not include the hidden frames in the TOC (thereby reporting a noangle TOC). Thus, depending on the client, the TOC of a disc reported one device may differ from the TOC of the same video disc reported by another device. In one embodiment, a video products database may include both angle TOCs and noangle TOCs for discs with scenes shot from multiple angles. If a matching request from a client indicates whether the source TOC is an angle TOC or a noangle TOC, the matching against the correct type of the TOC is attempted first. Otherwise, the video recognition service attempts to match the source TOC with an angle TOC from the database first and then attempt to match the source TOC with a noangle TOC. There may also be other types of TOCs besides angle and noangle, e.g., where a client generates TOCs utilizing an algorithm that is different from the algorithm used by the video recognition service. In such cases, the client may provide a string identifying the algorithm used to generate the TOC, such that the video recognition service may perform appropriate matching operations.

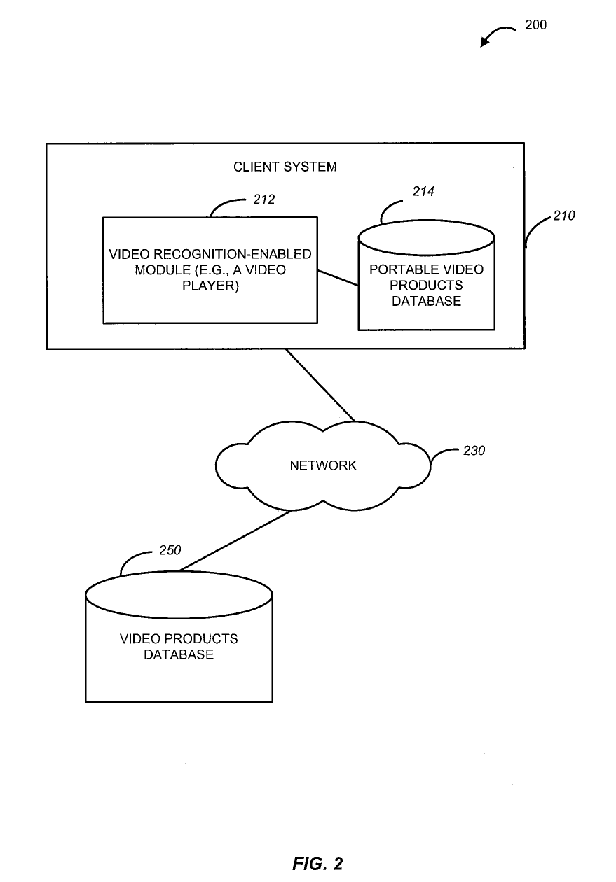

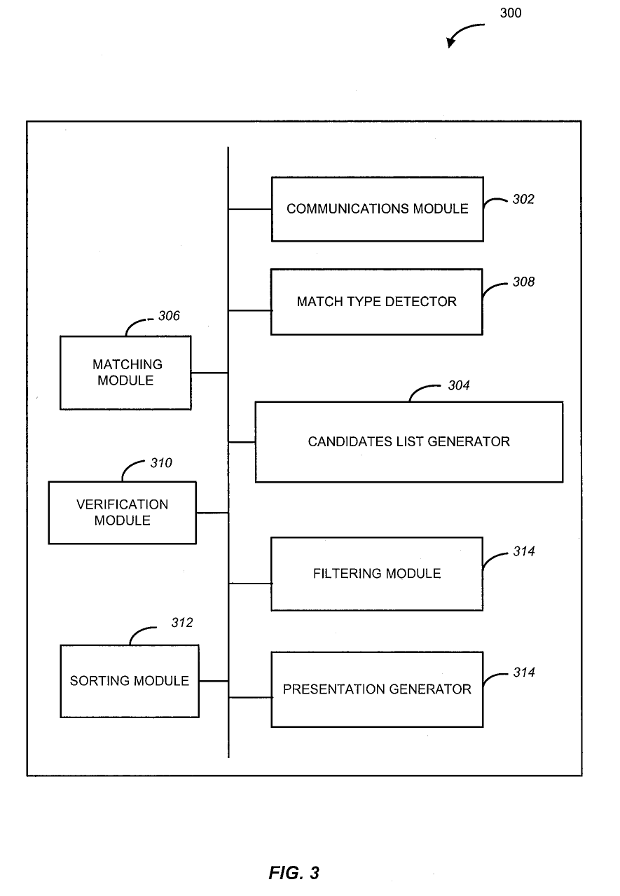

Returning to FIG. 1, while the video recognition service 142 is shown as residing on the server system 140, such that a source TOC is received from the client system 110 over a network connection and processed at the server system 140, in other embodiments a video recognition service may be provided with a video recognition-enabled module at a client system, as shown in FIG. 2. FIG. 2 is a diagrammatic representation of an environment 200 within which an example method and system for recognition of video content is provided at a client system, in accordance with one example embodiment. As shown in FIG. 2, the environment 200 includes a client system 210 that hosts a video recognition-enabled module 212 that includes a video recognition service. The processing of a source TOC may be performed by the video recognition-enabled module 212, utilizing a portable video products database 214. The portable video products database 214 may correspond to a video products database 250 that may be accessible via a communications network 230. An example video recognition system is illustrated in FIG. 3.

FIG. 3 is a block diagram of a video recognition system 300, in accordance with one example embodiment. As shown in FIG. 3, the system 300 includes a communications module 302, a candidates list generator 304, a matching module 306, match type detector 308, and a verification module 310. Various modules included in the video recognition system 300 may be implemented as software, hardware, or a combination of both.

The communications module 302 may be configured to receive (e.g., from the client system 110 of FIG. 1 or from a device hosted locally with respect to the system 300) a source table of contents (TOC) related to video content, the source TOC comprising values associated with one or more titles, chapters, and a source playback length reflecting the playback length of the entire associated video disc. A title from a TOC is a value reflecting the time length associated with the playing of a video segment associated with the title. A title may be further segmented into chapters, and a TOC may include one or more chapters associated with a title. A chapter from a TOC may reflect the time length, video frame count, or other value associated with the playing of a video segment associated with the chapter. Although in the specific cases of DVD and Blu-ray a hierarchical distinction of titles and chapters may be made, the video recognition system described herein is not restricted to these two levels of hierarchies. For example, there may be only chapters (flat hierarchy) or titles, chapters, scenes (several scenes in a chapter), cuts (or shots taken from differing camera positions that ultimately form, e.g., a dialog scene or a car chase scene), and ultimately frames.

The candidates list generator 304, the matching module 306, and the match type detector 308, referred together as a search and match module, may be utilized to interrogate a video products database with the source TOC to determine one or more match results, utilizing an exact matching technique or a fuzzy matching technique. The match type detector 308 may be configured to determine a match type associated with the received source TOC. Example match types include an exact match, a re-release match, a title match, and aggressive match. The candidate list generator 304 may be configured to determine a list of candidate TOCs from a video product database, based on the type of the match request. The matching module 306 may be configured to compare the source TOC to each candidate TOC from the list of candidate TOCs, utilizing a fuzzy matching technique, and to determine the one or more match results based on the results of the comparisons. The matching module 306, in some embodiments, may be capable of performing exact matches, as well as fuzzy matches, such as re-master matches and title matches. The verification module 310 may be configured to eliminate potential false positive matches from the one or more match results. The system 300 may further include a sorting module 312 to sort match results, as described further below, a filtering module 314, and a presentation generator 316 to generate a presentation of the one or more match results. The filtering module 314 may be configured to determine the order of presentation of the match results based on respective types or categories of the match results (e.g., based on whether a reference TOC from the match results is associated with video of the same TV system type as the source TOC). The filtering module 314 may also be configured to eliminate results that were determined to be of no interest to the user. For example, the client may send additional qualifying information together with the source TOC, such as the preferred language of the result, the region of the product they are looking up, the TV system of their product (such as NTSC or PAL), the aspect ratio of their product, as well as other types of qualifying information. This qualifying information may be used as filters if more than one result is found. If the matching results include results associated with region 1 and region 2, while the client specified only region 1, the video recognition system may remove all result that are not from region 1. If, on the other hand, no match results are from region 1, the video recognition system returns match results for region 2.

As mentioned above, a reference TOC that is present in a candidates list generated by the candidates list generator 304 is compared to the source TOC by the matching module 306. The matching module 306, as well as other modules in the system 300, may utilize various matching parameters, e.g., match thresholds, that may be either hard coded or configurable. Match thresholds may be expressed, e.g., in fractional percentages or in frame counts. Some examples of match thresholds are discussed below.

A threshold, below which two chapter lengths (time lengths), when compared, are considered effectively identical, may be termed “exact match absolute threshold.” This parameter may be set to a very small value to allow for a tiny time variation between two TOCs. If desired, a zero value may indicate that no variation is allowed between two chapters for them to be considered the same. An example value of an exact match absolute threshold may be selected to be 0.5% or less. If rounding causes the allowable difference to be computed as zero, at least one frame of variation may be allowed (unless no variation is allowed).

A threshold, below which the average difference between the set of chapters in two video disc titles are considered similar enough to be re-master matches of each other, may be termed “re-master match average threshold.” An example value of a re-master match average threshold may be selected to be 10%, e.g., in order to accommodate differences between NTSC and PAL, and to also allow for possible random variation between disc pressings. If rounding causes the allowable difference to be computed as zero, at least one frame of variation is allowed.

A threshold, above which two sets of chapters would not be considered matches if exceeded by the difference of any one of the corresponding chapter pairs in those sets, may be termed “re-master match absolute threshold.” For example, if video content that has two titles, each with ten chapters, is compared to another video disc (the TOC of another disc), and if nine of the corresponding chapters in the two TOCs are identical, but one of the chapters differs more than the threshold, then the two TOCs (and thus the two associated video discs) are not a match. This parameter should be set to a value representing the maximum desirable variation in a single chapter, such as might occur when a small amount of blank filler is inserted, or when a seller (such as a chain store) insists on removing small objectionable portions of a scene that is found in the mainstream version of a movie.

The percentage of the length of the longest title, for which other titles on the disc would also be considered a main title may be termed “main title relative threshold.” The main title relative threshold may be used for determining which titles in multi-feature discs, such as TV show discs, are main titles rather than trailers or special features. An example main title relative threshold value may be set at 80%, though it could be tighter if the matching is targeted mainly at discs that carry very similar multiple features (such as, e.g., TV shows) rather than, e.g., compilations of unrelated shorts of various lengths.

A title length, below which a title is ignored for the purposes of matching, may be termed “interesting title absolute threshold,” as titles below this threshold are considered uninteresting. Titles that are very short are of little value for use in matching, as they are generally menu animations, filler and the like. Moreover, indexing very short titles may lead to resource consumption and slow lookups. An interesting title absolute threshold is an absolute length, expressed in seconds (e.g., converted from the number of frames). An example value of an interesting title absolute threshold is 30-60 seconds. Any title that is not a main title that falls under the interesting title absolute threshold may be ignored for matching purposes because it is considered “uninteresting” with respect to determining the identity of the disc, as these uninteresting titles do not contribute significantly to the meaningful content of the disc. If, however, all titles on a disc fall under the threshold, then the interesting title absolute threshold may be ignored, in order to allow recognition of discs that consist only of very short titles. Other thresholds that may be used by a system for video disc recognition may include minimum exact chapter count, minimum chapter count, maximum exact chapter count, maximum chapter count, and maximum title count.

In order to avoid false positives when comparing titles with few chapters, any title with less than the minimum exact chapter count value must match bit-for-bit in order to be considered exactly the same; titles failing this are demoted to at best a re-master match. This overrides the exact match absolute threshold when the chapter count is too low. An example value of the minimum exact chapter count may be 5 or more. When the minimum chapter count threshold is used, individual titles in a TOC must have more chapters than this value in order for the TOC to be a title match of another TOC. Additionally, the entire TOC may be required to have more chapters than the minimum chapter count threshold in order to be considered a re-master match of another TOC.

The matching algorithm allows fuzzy matching for titles with varying chapter counts. This approach is permitted in order to accommodate devices that are not capable of returning more than a fixed number of chapters per title. However, in order to make matching feasible, a recognition-enabled module (whether an application or a device) may be required to return at least a minimum number of chapters per title, for titles that have more than the minimum chapter count. For example, if the minimum chapter count is 15 and a title in a source TOC has 20 chapters, a recognition-enabled module (also referred to as a client) may omit the last 5 chapters and a match would still be allowed. This threshold applies to client-supplied chapters in a query. While in may cases titles in a video product database (also referred to as a media database), include all chapters, the video recognition system may also receive submissions of TOCs that are not necessarily complete. Therefore, match requests for source TOCs that have more chapters than a corresponding TOC in the database may also be permitted. In one embodiment, when comparing two titles, the video recognition service may require that the shortest of the two titles has at least 15 chapters. If one of the titles that is being compared has less than 15 chapters, both titles must have the same chapter count.

Maximum chapter count threshold indicates that, when comparing two titles in two TOCs, the number of chapters that will be compared is not greater than the maximum chapter count. In order to be reasonably certain of correct matching, not all chapters need to be compared, as certainty may be reached after a finite number of chapters. This is a speed and memory consumption optimization and need not be observed for proper matching.

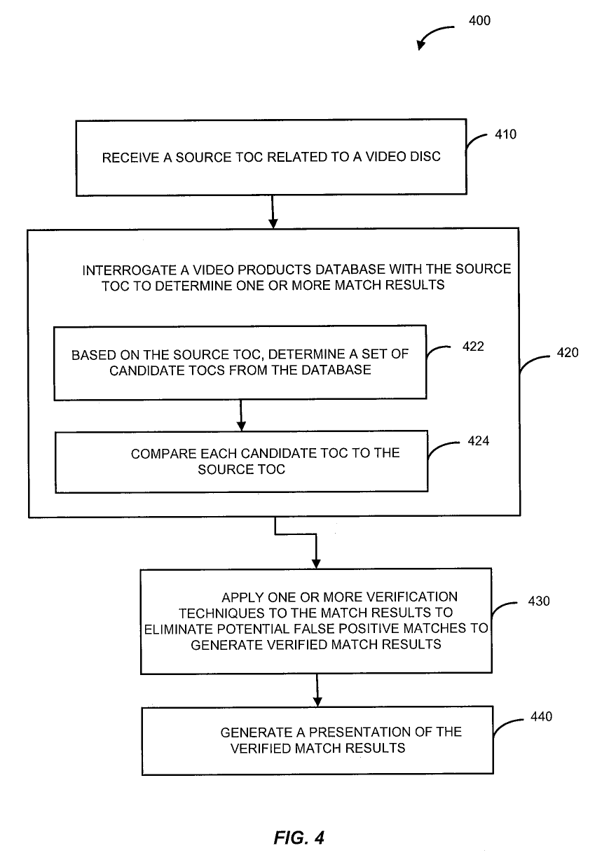

Maximum title count threshold indicates that, when comparing two TOCs, not all titles need be compared in order to achieve reasonable certainty. Some disc types may have hundreds or thousands of titles, though only a small number of meaningful/interesting titles need be compared. The maximum title count threshold limits the number of meaningful titles to be compared. An example maximum title count threshold may be selected as a maximum of 50 titles. As above, this is an optimization, and this limit may be ignored if desired. An example method to determine any TOCs from a video products database that match a source TOC received from a recognition-enabled module can be described with reference to FIG. 4.

FIG. 4 is a flow chart of a method 400 to provide a method to determine any matching TOCs in a video products database with respect to a source TOC, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the video recognition system 300 shown in FIG. 3.

As shown in FIG. 4, the method 400 commences at operation 410, when the communications module 302 of FIG. 3 receives a source TOC (e.g., a TOC associated with a video disc in a video drive) and an associated match request. At operation 420, a search and match module (that, in one embodiment, corresponds to the candidates list generator 304 and the matching module 306 of FIG. 3 taken together) interrogates a video products database with data associated with the source TOC to determine one or more match results. The process of interrogating may be performed using exact or fuzzy (non-exact) matching techniques. As shown in FIG. 4, the operation 420 may be viewed as multiple sub-operations. At operation 422, the candidates list generator 306 of FIG. 3 determines a set of candidate TOCs from a video products database. The set of candidate TOCs may be determined by performing an index look-up, according to a match type associated with the source TOC. A match type may be determined by the match type detector 308 of FIG. 3. As mentioned above, if the type of the match request is a re-master (or re-release) match request, the set of candidate TOCs from the video product database consists of all TOCs from the database that include all interesting titles from the source TOC.

At operation 424, the matching module 306 of FIG. 3 compares all candidate TOCs from the set of candidate TOCs to the source TOC. Based on the determined type of the match request, the matching module 306 may identify a candidate TOC from the database as a match if the candidate TOC includes titles that match all titles from the source TOC, even if a playback length associated with the candidate TOC is not identical to the playback length in the source TOC but is sufficiently similar. If the requested match is a title match, the matching module may identify a candidate TOC from the database as a match if the candidate TOC includes at least one title that matches a title from the one or more main titles from the source TOC. Another example match type is a so-called aggressive match, where the matching module 306 may identify a candidate TOC from the database as a match even if the candidate TOC includes a subset of the chapters from the source TOC. Aggressive match, according to one embodiment and as mentioned above, ignores certain differences between two video products that may be releases of a video disc in different countries that result in removing (or reinstating) certain scenes within a title. For example aggressive matching may permit a scene (or a chapter) to be missing for every certain number of chapters in a title.

Returning to FIG. 4, at operation 430, the verification module 310 of FIG. 3 applies one or more verification techniques to the one or more match results determined at operation 420, in order to eliminate potential false positive matches. For example, applying a verification technique may include determining an average difference between chapter lengths associated with the source TOC and corresponding chapter lengths associated with a suspect match result from the one or more match results, determining that the average difference is greater than a threshold value, and eliminating the suspect match result from the one or more match results. Another example of applying of a verification technique comprises determining a set of values reflecting respective chapter length differences, determining that a difference between a first value from the set of values and a second value from the set of values is greater than a threshold value and eliminating the suspect match result from the one or more match results. A chapter length difference may be computed as a difference between a length of a chapter from the source TOC and a length of a corresponding chapter from a suspect match result from the one or more match results.

If the search and match module returns multiple match results, these results may be sorted by the sorting module 312 of FIG. 3 as follows. Results may be first sorted by the number of matching main titles. This step may be skipped for exact and re-master matches, as these matches assume that the source and reference TOCs have the same number of matching titles. Results may be then sorted by closeness of match. For re-master matches, for example, the closeness may be defined as the average difference of all chapter lengths in the matching reference TOC compared to the source TOC. If two items have similar closeness then the next criterion is used. Results are then sorted by popularity. If two match results have a similar popularity, they are sorted by the next criterion. Finally, match results that have been certified by editors as high-quality data may be placed higher in the match results list, than those that have not been certified by editors as high-quality data. It will be noted, that other sorting approaches may be applied to the match results. The sorting of match results, if implemented as part of the video disc recognition service, may be provided as an optional feature.

In some embodiments, match results may be filtered by the filtering module 314 of FIG. 3, utilizing various parameters supplied in the user query associated with a TOC received at the communications module 302 of FIG. 3. For example, the filtering module 314 may determine whether a reference TOC from the match results is associated with video of the same TV system type as the source TOC (e.g. NTSC vs. PAL), whether a reference TOC is associated with video disc that is encoded with the same region information as the source TOC, etc, and present the match results in an order according to the results of filtering. In some embodiments, the video recognition system may categorize a video disc as a “first release” product, a “compilation” product, etc. The video recognition system may bubble “first release” products to the top of the result list if the client is more interested in results that come from the first public release of a product. There may be other editorial notations that may be used for filtering. A presentation of the verified match results is generated at operation 440.

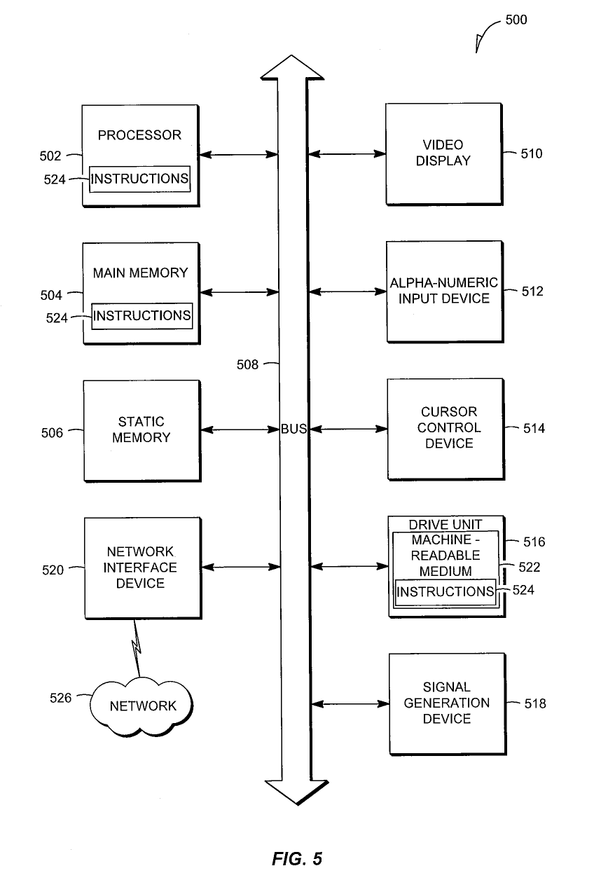

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system for recognition of video content has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented system comprising:
a communications module to receive a source table of contents (TOC) related to temporally segmented video content, the source TOC comprising one or more titles and a source playback length; and
a search and match module to interrogate a database with the source TOC to determine one or more match results, utilizing a fuzzy matching technique.

2. The system of claim 1, wherein the search and match module comprises:
a match type detector to determine a match type associated with the received source TOC;
a candidate list generator to determine a list of candidate TOCs from a video product database, based on the type of the match request; and
a matching module to:
compare the source TOC to each candidate TOC from the list of candidate TOCs, utilizing a fuzzy matching technique; and
determine the one or more match results based on the results of the comparisons.

3. The system of claim 2, wherein the matching module is to identify a candidate TOC from the list of candidate TOCs as a match if:
the candidate TOC includes titles that match all titles from the source TOC;
a playback length from the candidate TOC is not identical to the source playback length; and
the playback length from the candidate TOC differs from the source playback length by a value not exceeding a threshold value.

4. The system of claim 2, wherein the matching module is to identify a candidate TOC from the list of candidate TOCs as a match if the candidate TOC includes a title that matches at least one title from the source TOC.

5. The system of claim 1, wherein a main title from the source TOC is associated with a plurality of chapters, wherein the matching module is to identify a candidate TOC from the list of candidate TOCs as a match if the candidate TOC includes a subset of the plurality of chapters.

6. The system of claim 1, comprising a verification module to eliminate potential false positive matches from the one or more match results.

7. The system of claim 1, wherein the temporally segmented video content is stored on one of:
a digital versatile disc (DVD);
a Blu-ray disc;
a High-Definition/Density (HD) DVD;
a Video Compact Disc (VCD);
a Super Video Compact Disc (sVCD); and
a Laserdisc.

8. The system of claim 1, wherein the temporally segmented video content corresponding to the source TOC is stored in a permanent memory of a computer system.

9. The system of claim 7, wherein the temporally segmented video content is stored on a video disc.

10. The system of claim 1, wherein the communications module is to receive a source TOC from a client computer system, via a network connection.

11. The system of claim 1, comprising a presentation generator to generate a presentation of the one or more match results.

12. A computer-implemented method comprising:
using one or more processors to perform operations of:
receiving a source table of contents (TOC) related to temporally segmented video content, the source TOC comprising one or more main titles and a source playback length; and
interrogating a database with the source TOC, utilizing a fuzzy matching technique, to determine one or more match results.

13. The method of claim 11, wherein the interrogating of the database comprises:
determining a set of candidate TOCs from the database, utilizing the source TOC; and
comparing a candidate TOC from the set of candidate TOCs to the source TOC.

14. The method of claim 12, wherein the fuzzy matching technique comprises identifying a candidate TOC from the database as a match if:
the candidate TOC includes titles that match all titles from the source TOC;
a playback length associated with the candidate TOC is not identical to the source playback length; and
the playback length associated with the candidate TOC differs from the source playback length by a value not exceeding a threshold value.

15. The method of claim 12, wherein the fuzzy matching technique comprises identifying a candidate TOC from the database as a match if the candidate TOC includes at least one title that matches a title from the one or more main titles from the source TOC.

16. The method of claim 12, wherein:
a main title from the one or more main titles is associated with a plurality of chapters; and
the fuzzy matching technique comprises identifying a candidate TOC from the database as a match if the candidate TOC includes a subset of the plurality of chapters.

17. The method of claim 11, comprising applying a verification technique to the one or more match results to eliminate potential false positive matches.

18. The method of claim 16, wherein the applying of the verification technique comprises:
determining an average difference between chapter lengths associated with the source TOC and corresponding chapter lengths associated with a suspect match result from the one or more match results;
determining that the average difference is greater than a threshold value; and
eliminating the suspect match result from the one or more match results.

19. The method of claim 16, wherein the applying of the verification technique comprises:
determining a set of values reflecting respective chapter length differences, a chapter length difference is a difference between a length of a chapter from the source TOC and a length of a corresponding chapter from a suspect match result from the one or more match results;
determining that a difference between a first value from the set of values and a second value from the set of values is greater than a threshold value; and
eliminating the suspect match result from the one or more match results.

20. The method of claim 11, wherein the temporally segmented video content is stored on a digital versatile disc (DVD) or a Blu-ray disc.

21. The method of claim 11, wherein the temporally segmented video content corresponding to the source TOC is stored in a permanent memory of a computer system.

22. A machine-readable medium having instruction data to cause a machine to:
receive a source table of contents (TOC) related to temporally segmented video content, the source TOC comprising one or more titles and a source playback length; and
interrogate a database with the source TOC to determine one or more match results, utilizing a fuzzy matching technique.
